(19) United States
(12) Patent Application Publication
(10) Pub. No.: US 2023/0081209 A1
(43) Pub. Date: Mar. 16, 2023

(54) 3D PRINTING DEVICE HAVING AN ADVANTAGEOUS GEOMETRY OF THE BUILD AREA

(71) Applicant: Voxeljet AG, Friedberg (DE)

(72) Inventors: Ingo Ederer, Geltendorf (DE); Christoph Scheck, Augsburg (DE); Melanie Weigel, Augsburg (DE)

(21) Appl. No.: 17/777,328

(22) PCT Filed: Nov. 17, 2020
(86) PCT No.: PCT/DE2020/000285

§ 371 Date: May 17, 2022

(30) Foreign Application Priority Data
Nov. 18, 2019 (DE) 10 2019 007 983.3

(51) Int. Cl. B29C 64/153; B29C 64/165; B29C 64/205; B29C 64/236; B29C 64/245; B29C 64/291; B29C 64/364; B29C 64/393

(52) U.S. Cl. CPC B29C 64/153; B29C 64/165; B29C 64/205; B29C 64/236; B29C 64/245; B29C 64/291; B29C 64/364; B29C 64/393; B33Y 10/00

(57) ABSTRACT

The invention relates to a 3D printing device having an advantageous geometry of the build area.

### CLAIM OF PRIORITY

This application is a national phase filing under 35 USC § 371 from PCT Patent Application serial number PCT/DE2020/000285 filed on Nov. 17, 2020 and claims priority therefrom. This application further claims priority to German Patent Application Number DE 102019007983.3 filed on Nov. 18, 2019. International Patent Application number PCT/DE2020/000285 and German Patent Application number DE 102019007983.3 are each incorporated herein by reference in its entirety.

### FIELD

The invention relates to a 3D printing device having an advantageous geometry of the build area.

### DESCRIPTION

European Patent EP 0 431 924 B1 describes a process for producing three-dimensional objects based on computer data. In the process, a thin layer of particle material is deposited on a platform by means of a recoater and has a binder material selectively printed thereon by means of a print head. The particle region with the binder printed thereon bonds and solidifies under the influence of the binder and, optionally, an additional hardener. Next, the build platform is lowered by one layer thickness or the recoater/print head unit is raised and a new layer of particle material is applied, the latter also being printed on selectively as described above. These steps are repeated until the desired height of the object is achieved. Thus, the printed and solidified regions form a three-dimensional object (3D part, molding).

Upon completion, the object made of solidified particle material is embedded in loose particle material, from which it is subsequently freed. For this purpose a suction device may be used, for example. This leaves the desired objects which are then further cleaned of any residual powder, e.g. by brushing it off.

Other powder-based rapid prototyping processes, e.g. selective laser sintering or electron beam sintering or high-speed sintering, work in a similar manner, also applying loose particle material layer by layer and selectively solidifying it using a controlled physical source of radiation.

In the following, all these processes will be summarized by the term “three-dimensional printing process” or “3D printing process”.

In the known devices of 3D printing machines, the build field and build area are tailored according to the other requirements of the machine. A primary design goal may also be to provide a specific build volume in order to print correspondingly small or large parts.

In the different 3D printing processes such as laser sintering, ink jet binding, high-speed sintering processes, etc., different process conditions are applied or required depending on the process, which determines the further machine design and other process parameters. The building materials and printing components used also have an influence here.

In particular, the build volume of known 3D printing machines is influenced by many factors. On the one hand, there are requirements that are given by the parts to be printed. For example, if the customer wants to produce a part with a main dimension of 500 mm, the 3D printer should have a build volume that has this dimension in at least one direction.

On the other hand, process parameters such as the build volume speed must also be taken into account when selecting the build volume. The build volume speed determines how long the 3D printer needs to process a full build volume. Advantageously, in an industrial 3D printer, the build volume and the build volume speed are selected in relation to each other so that a full job can be printed within 24 h and the system can be started with a new job. In this case, a 3D printer can be operated in single-shift operation with high utilization. However, the prerequisite is that the 3D printer can be operated unmanned, e.g. overnight. If the build volume speed of the 3D printer is very high compared to the build volume, the build volume can also be selected so that one job can be completed within a day shift of 8-10 h and another job can be built overnight in less than 14 h. A further reduction in the ratio of build volume to build volume speed then requires either a multi-shift operator presence or further automation of the pre- and post-processes in order to take advantage of the higher productivity.

In addition, the build volume of a 3D printer is also defined by process limits. The schematic drawing in FIG. 1 shows, for example, a commercially available device as used in laser sintering. In this case, a laser 105 is deflected via a mirror device 106 before passing through a protective glass and/or lens system 107 to draw a FIG. 102 on the build field surface 101. At the point of incidence of the laser on the particle material, the material is sintered, creating a molded article 102 layer by layer. The process chamber is bounded at the top by the lid 108 to maintain temperature and prevent convection. A square process surface is usually preferred for the device. The reason for this is the limited operating range of the laser optics, as a result of the size of the expensive protective glass 107 and the loss of focus of the laser beam at maximum deflection angles. Accordingly, typical build field dimensions are 200 mm to 400 mm square. Larger dimensions make temperature management more difficult, which requires the build field temperature to be as constant as possible. In addition, the additional cost of the larger optics required to focus the laser and the additional laser power required are not commensurate with the build area gained.

It is true that there are devices available on the market with two laser systems to double the operable process surface in one dimension. However, quality losses are to be expected, since, among other things, alignment at the interface of the two laser fields proves difficult.

In another 3D printing process, which is known in the art as “high-speed sintering”, solidification of the particle material is effected by input of infrared radiation. The particle material is thus bonded physically by a fusing process. In this case, advantage is taken of the comparatively poor absorption of thermal radiation in colorless plastic materials. Said absorption can be increased multiple times by introducing an IR acceptor (absorber) into the plastic material. The IR radiation can be introduced by various means, e.g. a bar-shaped IR lamp, which is moved evenly over the build field. Selectivity is achieved by the specific printing of the respective layer with an IR acceptor.

In the printed locations, the IR radiation thereby couples much better into the particle material than in the unprinted regions. This results in selective heating within the layer beyond the melting point and, consequently, in selective solidification. This process is described, for instance, in EP1740367B1 and EP1648686B1.

Since no laser system is employed in 3D printing processes using high-speed sintering, the limitations of laser sintering described above do not apply in this case.

However, it can be noted that in known 3D printing machines, the geometry and dimensioning of the build area are not always optimally selected in relation to other machine and process features.

This can have a detrimental effect on the process speed or/and other machine and process parameters, thus potentially leading to suboptimal processes and involving disadvantages in terms of cost-effectiveness, quality or other drawbacks.

It is therefore an object of the present invention to provide a device which is improved with regard to the geometry of the build area or/and the dimensions of the build surface or/and of the build area for a 3D high-speed sintering process or a 3D laser sintering process, or at least to mitigate or completely avoid the disadvantages of the prior art.

It is therefore a further object of the present invention to provide a device which improves the geometry of the build area or/and the dimensions of the build surface or/and of the build area and the interaction with other process parameters in a 3D high-speed sintering process or a 3D laser sintering process, or which at least mitigates or helps to completely avoid the disadvantages of the prior art.

### BRIEF SUMMARY OF THE DISCLOSURE

In one aspect, the disclosure relates to a 3D printing device with an optimized geometry of the build area for a high-speed sintering process or a laser sintering process or a sintering process or a multi-jet fusion process, wherein the geometry axes of the build area are in the size ratio Y>X>Z and/or wherein the ratio of Y:X is between 1.1 to 3.0.

In another aspect, the disclosure relates to a 3D printing device for use in a high-speed sintering process or a laser sintering process or a sintering process or a multi-jet fusion process, wherein the build area is characterized by an X-axis and a Y-axis forming the build field, and a Z-axis, wherein in the build area the size ratio Y>X>Z is present and/or wherein the ratio of Y:X is between 1.1 to 3.0.

In another aspect, the disclosure relates to a combination of the geometry of the build area disclosed herein with a double-cooled sintering assembly, wherein a first closed cooling air circuit is coupled to a second, preferably fluid-based, cooling air circuit.

In another aspect, the disclosure relates to a high-speed sintering process or laser sintering process or a sintering process or a multi-jet fusion process for producing a molding by means of particle material application and selective solidification, the process comprising all further process steps and process means necessary for a 3D printing process, the process being carried out in a build area which is characterized by an X-axis and a Y-axis, forming the build area, and a Z-axis, wherein in the build area the size ratio is Y>X>Z and/or wherein the ratio of Y:X is between 1.1 to 3.0.

### BRIEF DESCRIPTION OF THE DRAWINGS

FIG. 1 shows a prior art sintering machine with a laser.

FIG. 2 shows the influence of each dimension of the process field on the processing speed in additive manufacturing using the high-speed sintering process.

FIG. 3 shows scaling of the cooling time t_{c} with the magnification in one dimension, with constant X and Y.

FIG. 4 shows that, from the above figures, a preferred dimensional ratio of Y>X>Z accordingly results when viewed as a whole, as schematically illustrated here. The individual layers of the building process are shown, as are the molding sections created on the surface.

FIG. 5 shows an exemplary concept of a device for additive manufacturing using the high-speed sintering process, resulting from the considerations on the dimensional ratio of the process field disclosed herein; the view from above (XY plane) and from the front (XZ plane) is shown here.

FIG. S2 shows a section through a sintering assembly device as a consequence of the build field geometry in the XZ plane.

FIG. S3 shows a sintering unit in a lateral view (YZ plane) with air flow.

FIG. S4 shows a sintering unit frontally in the XZ plane with fans.

FIG. H1 shows a prior art panel heater.

FIG. H2 shows an infrared panel heater with temporal and local control and the resulting surface temperature.

FIG. H3 shows an emitter unit according to the disclosure, also illustrating an exemplary arrangement of measuring instruments.

FIG. H4 shows an exemplary emitter unit according to the disclosure with an arrangement of groups of infrared emitters, which are combined into individual heating circuits.

FIG. H5 schematically shows an exemplary embodiment of emitters in an emitter unit according to the disclosure with closed-loop control.

### DETAILED DESCRIPTION OF THE DISCLOSURE

The object underlying the application is achieved by a 3D printing device for use in a high-speed sintering process or a laser sintering process or a sintering process or a multi-jet fusion process, characterized in that the build area is characterized by an X-axis and a Y-axis forming the build field and a Z-axis, wherein the size ratio Y>X>Z is present in the build area and/or wherein the ratio of Y:X is between 1.1 to 3.0, preferably 1.2 to 2.0.

The object underlying the application is achieved by a high-speed sintering process or a laser sintering process or a sintering process or a multi-jet fusion process for producing a molding by means of particle material application and selective solidification, the process comprising all further process steps and process means necessary for a 3D printing process, the process being carried out in a build area which is characterized by an X-axis and a Y-axis, forming the build area, and a Z-axis, wherein the size ratio Y>X>Z is present in the build area and/or wherein the ratio of Y:X is between 1.1 and 3.0, preferably 1.2 to 2.0.

In the following, several terms will be defined more precisely. Otherwise, the terms used shall have the meanings known to the person skilled in the art.

In the sense of the disclosure, “layer building processes” or “3D printing processes” or “3D processes” or “3D printing”, respectively, are all processes known from the prior art which enable the construction of parts in three-dimensional shapes and are compatible with the process components and devices further described herein.

As used in the disclosure, “binder jetting” means that powder is applied in layers onto a build platform, one or more liquids is/are printed on the cross-sections of the part on this powder layer, the position of the build platform is changed by one layer thickness with respect to the previous position, and these steps are repeated until the part is finished.

In this context, binder jetting also refers to layer building processes that require a further process component such as layer-by-layer exposure, e.g. with IR or UV radiation.

In the “high-speed sintering process” as defined in the disclosure, a thin layer of plastic granules, such as PA12 or TPU, is applied to a build platform (build field), which is preferably heated. Next, an inkjet print head moves over a large area of the platform and wets the areas of the build field with infrared light-absorbing ink (IR absorber, IR acceptor) where the prototype is to be created. The build platform is then irradiated with infrared light. The wetted areas absorb the heat, causing sintering of the underlying powder layer. However, the unprinted powder remains loose. After sintering, the build platform is lowered by one layer thickness. This process is repeated until the construction of a part is completed. The sintered parts are then cooled in a controlled manner in the build area before they can be removed and unpacked. It may also be advantageous in this regard to use an overhead lamp or an emitter assembly in addition to a sintering lamp, which use different wavelength spectra with substantially no overlap in wavelength spectrum. In one variation, a so-called detailing agent can be printed in addition to the IR absorber, said agent serving to cool the areas printed with it. A variation of the high-speed sintering process is also known as the fusion jet process, wherein the print head injects a heat-conducting fluid (often referred to as a “fusing agent,” which corresponds to the absorber) onto a layer of the particle material. Immediately after printing, a heat source (infrared light) is applied. The areas to which the fusing agent has been applied are heated more strongly than the powder without this liquid. Thus, the required areas are fused. Another additive is then used, also known as a detailing agent, which is used for insulation. This selective impression occurs around the areas on which the fusing agent or absorber has been printed. Said additive is intended to promote sharp edge formation. This aim is to be achieved by making the temperature differences between printed and unused powder more significant. A process using these two printing liquids can also be referred to as a multi-jet fusion process.

“Laser-sintering process” as used in the disclosure means a 3D printing process in which the particle material is selectively solidified using a laser.

A “3D molding”, “molded article” or “part” in the sense of the disclosure means any three-dimensional object manufactured by means of the process according to the invention or/and the device according to the invention and exhibiting dimensional stability.

“Build area” is the geometric location where the particle material bed grows during the manufacturing process by repeated coating with particle material or through which the bed passes when applying continuous principles. The build area is generally bounded by a bottom, i.e. the build platform, by walls and an open top surface, i.e. the build plane. In continuous principles, there usually are a conveyor belt and limiting side walls. The build area can also be designed in the form of what is called a job box, which constitutes a unit that can be moved in and out of the device and allows batch production, with one job box being moved out after completion of a process to allow a new job box to be moved into the device immediately, thereby increasing both the production volume and, consequently, the performance of the device. The build area can also be described by the axes X, Y, Z.

As the “building material” or “particle material” or “powder” or “powder bed” in the sense of the disclosure, all flowable materials known for 3D printing may be used, in particular in the form of a powder, slurry or liquid. These may include, for example, sands, ceramic powders, glass powders and other powders of inorganic or organic materials, such as metal powders, plastic materials, wood particles, fiber materials, celluloses or/and lactose powders, as well as other types of organic, pulverulent materials. The particle material is preferably a free-flowing powder when dry, but a cohesive, cut-resistant powder may also be used. This cohesiveness may also result from adding a binder material or an auxiliary material, e.g. a liquid. The addition of a liquid can result in the particle material being free-flowing in the form of a slurry. In general, particle materials may also be referred to as fluids in the sense of the disclosure.

In the present application, particle material and powder are used synonymously.

The “particle material application” is the process of generating a defined layer of powder. This may be done either on the build platform (build field) or on an inclined plane relative to a conveyor belt in continuous principles. The particle material application will also be referred to below as “recoating”.

“Selective liquid application” or “selective binder application” in the sense of the disclosure may be effected after each particle material application or irregularly, depending on the requirements for the molded article and for optimization of the molded article production, e.g. several times with respect to particle material application. In this case, a sectional image of the desired article is printed.

The “device” used for carrying out a process according to the disclosure may be any known 3D printer which includes the required parts. Common components include recoater, build field, means for moving the build field or other parts in continuous processes, job box, metering device and heating and irradiating means and other parts which are known to the person skilled in the art and will therefore not be described in detail herein.

The building material according to the disclosure is always applied in a “defined layer” or “layer thickness”, which is individually adjusted according to the building material and the process conditions. It is, for example, 0.05 to 5 mm, preferably 0.06 to 2 mm or 0.06 to 0.15 mm, particularly preferably 0.06 to 0.09 mm.

“Recoater” or “material application means” as used in the disclosure refers to the unit by means of which a fluid such as particle material, e.g. mineral or metallic materials or plastics, wood in particulate form, or mixtures thereof, is applied to the build field. The unit may consist of a fluid reservoir and a fluid application unit. According to the present invention, the fluid application unit comprises a fluid outlet and a “coating knife device”. Said coating knife device may be a coating blade. However, any other conceivable, suitable coating knife device may be used. For example, rotating rollers or a nozzle are conceivable as well. Material can be fed via reservoirs in a free-flowing manner or via extruder screws, pressurization or other material conveying means.

A “coating blade” as defined in the disclosure is a substantially flat part made of metal or other suitable material, which is located at the outlet opening of the recoater and through which the fluid is discharged onto the build platform and smoothed down. A recoater may have one or two or more coating blades. A coating blade can be an oscillating blade that performs oscillations in the sense of a rotary motion when excited. Further, this oscillation can be switched on and off by a means for generating oscillations. Depending on the arrangement of the outlet opening, the coating blade is arranged “substantially horizontally” or “substantially vertically” within the meaning of the disclosure.

As used in the disclosure, the “feed container” or “preheating container” is a vessel that contains particle material and delivers an amount thereof to the recoater after each layer or after any number of layers. For this purpose, the feed container can advantageously extend over the entire width of a recoater. The feed container has a closure at the lower end that prevents the particle material from escaping unintentionally. The closure can be designed, for example, as a rotary feeder, a simple slider or other suitable mechanisms according to the prior art. A feed container as defined in the disclosure may contain particle material for more than one layer. Preferably, the feed container even contains particle material for the application of 20 or more layers. The particle material comes either via a conveyor line from a larger supply in the form of a silo or a big bag, or is filled manually into the container. Filling is preferably performed through an opening at the top edge. This allows the particle material to be conveyed in the feed container by gravity, thus eliminating the need for additional conveying means in the container. The feed container may also have vibration mechanisms to prevent bridging of the particle material in the container. The feed container has an area that receives the particle material, typically located between the sidewalls and the closure. According to the disclosure, it is advantageous for a heating means to be arranged in the area that receives the particle material. The heating means is arranged so that the particle material flows around the heating means, thus improving the heating of the particle material. The feed container may be stationary, in which case it can be located, for example, above the stopping position of the recoater or above the build field. Refilling can then be carried out as required or/and controlled by the volume quantity with pre-tempered particle material by moving the recoater toward or below the feed container. However, the feed container may also be detachably or non-detachably connected to the recoater. It may also be advantageous for design or/and cost reasons that the recoater is not heatable. The recoater may then have passive insulation. However, the recoater may not be heated at all, nor provided with insulation, if the preheated particle material is delivered to the recoater in a volume substantially equal to, or 1.2 to 2 times, a layer volume, allowing it to be applied to the build field with virtually no residence time in the recoater and thus with substantially no heat loss.

A “coolant” as used in the disclosure is a means capable of cooling a radiation-emitting unit, such as water or other liquid or a gas blower flow.

The “heating phase” in the sense of the disclosure refers to heating of the device at the beginning of the process. The heating phase is complete as soon as the actual temperature of the device reaches a stationary value.

The “cooling phase” in the sense of the disclosure refers to the time required to cool the particle material to such an extent that the parts contained therein are not subject to any significant plastic deformation when removing them from the build area, or the “cooling phase” in the sense of the disclosure is the time period that must be waited before moldings produced by the sintering process can be removed from the build area without damaging them. The cooling time is usually specified as the minimum time required when the outer sides of the build area are cooled to the maximum and is usually specified so that the hottest location of the build area volume is safely below the heat distortion temperature of the material used.

The “absorber” or “IR absorber” or “IR acceptor” in the sense of this disclosure is a medium which can be processed by an inkjet print head or any other device working in a matrix-like manner, which medium enhances the absorption of radiation for local heating of the building material. The absorber may also be in the form of particles, e.g. black toner. Absorbers may be applied uniformly or selectively, in different amounts. For example, the absorber may be applied as a mixture of absorbers with different absorption maxima, or different absorbers may be applied independently, e.g. one after another, in an alternating manner or in a predetermined sequence. Thus, applying different amounts allows the strength in the building material to be controlled and to selectively achieve different strengths, e.g. in the molding to be produced and the jacket surrounding it. The strength ranges from a strength as in the part itself to a strength that is only insignificantly above that of the building material without the absorber printed thereon. This allows temperature control in the build field/build area and also allows easy removal, if desired, of the jacket surrounding the produced part, which jacket serves the purpose of temperature control.

“Absorption” in the sense of this disclosure refers to the uptake by the building material of thermal energy from radiation. The absorption depends on the type of powder and the wavelength of the radiation.

“Energy input means”, in the sense of this disclosure, refers to a source of energy input into the build area or/and the particle material or/and the areas printed with absorber. This may be, for example, a source of energy for temperature control or heating of particle material, even before the absorber input. It may also include irradiation of the build field by stationary or mobile sources of radiation. If the source of radiation is used for solidification after input of the absorber, the absorber is adapted to the type of radiation and preferably optimized. This is intended to produce differences in heating between “activated” and “non-activated” powder. “Activated” means that, by the absorber printed therein, the temperature in these regions is increased as compared to the other regions in the build area and the particle material areas not printed with absorber.

“IR heating” as used in this disclosure specifically means irradiation of the build field by an IR emitter. The IR emitter may be either static or movable over the build field by a displacement unit. Using the absorber, the IR heating results in different temperature increases in the build field.

An “IR emitter” as used in the disclosure is a source of infrared radiation. Usually, incandescent filaments in quartz or ceramic housings are used to generate the radiation. Depending on the materials used, different wavelengths result for the radiation. In addition, the wavelength of this type of emitter also depends on its power.

An “overhead lamp” or “overhead emitter” or “emitter assembly” or “emitter unit” or “radiation unit” or “heating radiator” or “build field heater” as used in the disclosure is a source of radiation that is mounted above the build field and forms a functional unit. The wavelength of the emitted electromagnetic radiation is stationary and its radiant flux can be regulated. The emitter unit is a functional unit that emits electromagnetic radiation of a specific spectrum. It may contain individual emitters or a large number of emitters, which can be controlled individually or combined in groups. Optionally, it covers substantially the entire build field and is mounted at a position in the device, or it is smaller than the build field and may be movable across the build field.

“Sintering” or “melting” in the sense of this disclosure is the term for the partial coalescence of the particles in the powder. In this system, the build-up of strength is connected with the sintering.

The term “sintering window” in the sense of this disclosure refers to the difference in temperature between the melting point occurring when first heating the powder and the solidification point during the subsequent cooling.

The “sintering temperature” as used in this disclosure is the temperature at which the powder first begins to fuse and bond.

A “peripheral area” as used in the disclosure means the area of an emitter assembly that is located at the edge of the emitter assembly and can be delineated from the interior area. In this case, the peripheral area and the interior area form the total area of the emitter assembly in terms of its surface on which the emitter units are mounted.

“Interior area” as used in the disclosure means the area of an emitter assembly that is inside the emitter assembly and can be delineated from the peripheral area.

“Peripheral area of the build field” in the sense of the disclosure refers to the edges of the build field of the build area.

“Interior area of the build field” in the sense of the disclosure refers to the area of the build field of the build area which can be delineated from the “peripheral area of the build field”.

“3D printer” or “printer” or “3D printing machine” or “3D printing device” as used in the disclosure means the device in which a 3D printing process can take place. A 3D printer in the sense of the disclosure comprises a means for applying building material, e.g. a fluid such as a particle material, and a solidification unit, e.g. a print head or an energy input means such as a laser or a heat lamp. Other machine components known to the person skilled in the art and components known in 3D printing are combined with the above-mentioned machine components in individual cases, depending on the specific requirements. Alternatively, the term “device” can be selected.

A “build field” is the plane or, in a broader sense, the geometric location on or in which a particle material bed grows during the building process by repeated coating with particle material. The build field is frequently bounded by a bottom, i.e. the “build platform”, by walls and an open top surface, i.e. the build plane. The build field constitutes a part of the build area.

The process of “printing” or “3D printing” in the sense of the disclosure summarizes the operations of material application, selective solidification or imprinting and working height adjustment and takes place in an open or closed process or build area.

A “receiving plane” in the sense of the disclosure means the plane onto which the building material is applied. In accordance with the disclosure, the receiving plane is always freely accessible in one spatial direction by a linear movement.

According to the disclosure, “spreading out” or “application” or “deposition” means any manner in which the particle material is distributed. For example, a larger quantity of powder may be placed at the starting position of a coating pass and may be distributed or spread out into the layer volume by a blade or a rotating roller.

The “print head” or means for selective solidification in the sense of the disclosure usually consists of various components. Among other things, these can be printing modules. The printing modules have a large number of nozzles from which the “binder” is ejected as droplets onto the build field in a controlled manner. The printing modules are aligned with respect to the print head. The print head is aligned with respect to the machine. This allows the position of a nozzle to be assigned to the machine coordinate system. The plane in which the nozzles are located is usually referred to as the nozzle plate. Another means of selective solidification can also be one or more lasers or other radiation sources or a heat lamp. Arrays of such radiation sources, such as laser diode arrays, can also be considered. It is permissible in the sense of the disclosure to implement selectivity separately from the solidification reaction. Thus, a print head or one or more lasers can be used to selectively treat the layer and other layer treatment means can be used to start the solidification process. In one embodiment, an IR absorber is printed on the particle material, followed by solidification using an infrared source. A “print head” may have one or more print modules mounted in a special arrangement in an assembly.

The assembly is used in its entirety for wetting a surface—in this case a particle material on the build field—with liquid (printing liquid) according to the DOD principle.

“Printing module” as used in the disclosure means a unit for applying a liquid to a surface by means of the so-called ink-jet process according to the DOD principle.

“Layer treatment means” in the sense of the disclosure refers to any means suitable for achieving a certain effect in the layer. This may be the aforementioned units such as print heads or lasers, but also heat sources in the form of IR emitters or other radiation sources such as UV emitters, for example. Means for deionization or ionization of the layer are also conceivable. What all layer treatment means have in common is that their zone of action is distributed linearly over the layer and that, like the other layering units such as the print head or recoater, they must be guided over the build field to reach the entire layer.

“Drop-on-demand” or “DOD” or “DOD principle” as used in the disclosure refers to a method of applying a liquid to a surface, whereby the liquid becomes active only at those locations where application is desired.

“Sintering emitter assembly” or “sintering assembly” or “sintering lamp” as used in the disclosure means the device using which particle material surfaces wetted with IR acceptor are selectively heated above the melting temperature by means of electro-magnetic radiation. A “sintering assembly” as used in this disclosure is the energy input means capable of heating the process powder (particulate building material, particle material) above its sintering temperature. Said assembly may be stationary. In preferred embodiments, the “sintering assembly” is moved across the build field in such a way that, in coordination with the other device means, a useful layer buildup with selective solidification can be performed.

“Radiation transducers” within the meaning of the disclosure are elements which, when exposed to electro-magnetic radiation of a particular spectrum, modify that spectrum in essential characteristics of the distribution of wavelength intensities.

The “peak wavelength” in the sense of the disclosure is the wavelength of electro-magnetic radiation of an approximately Planckian spectrum which has the highest intensity and follows Wien's displacement law. Peak wavelength can also denote the wavelength that has the highest intensity for emitters that do not follow the Planck distribution.

“Overrun” as used in the disclosure refers to the additional space required when an assembly is moved completely across the build field from one end to the other on a linear axis without creating shadowing on the build field.

The “coupling” of cooling circuits, or of a cooling circuit with a cooling member, within the meaning of the disclosure is when two functionally different parts have a coupling point or connecting point where heat exchange can occur. For example, according to the disclosure, a closed air-cooling circuit is coupled to a liquid-based cooling circuit, and, thus, from the air-cooling circuit, which can receive heat from, for example, a radiation transducer, this heat is delivered to the liquid-based cooling circuit and then transported to the environment directly or possibly via another coolant, whereby, when a closed-loop control circuit is used, the temperature at, for example, the radiation transducer can be set to or maintained at a target temperature.

A “closed” air-cooling circuit, as defined in the disclosure, means that the air in the circuit is substantially circulated in the circuit and no supply air is supplied from the outside. In a specific embodiment, this circuit is sealed so that no contaminants, such as particles of building material, can enter this circuit and thus no maintenance of this circuit is required.

An “air-cooling circuit” in the sense of the disclosure refers to the circulation of air in a tube system of the sintering assembly, wherein the air or gas is circulated, for example, by further means such as fans.

A “liquid-based cooling circuit” as defined in the disclosure is a closed circuit whose coolant is a liquid, such as water, oil, or other known liquid coolants.

“Surface enlargement” as used in the disclosure refers to any means that increases a surface area for cooling purposes such as fins, ribs, etc. to increase cooling capacity.

“Cooling member” as used in the disclosure means a heat exchanger.

### DETAILED DESCRIPTION OF THE DISCLOSURE

The various aspects and advantageous embodiments of the disclosure will be described in more detail below.

The object underlying the application is achieved by a 3D printing device for use in a high-speed sintering process or a laser sintering process or a sintering process or a multi-jet fusion process, which is characterized in that the build area is characterized by an X-axis and a Y-axis, forming the build field, and a Z-axis, wherein the size ratio Y>X>Z is present in the build area and/or wherein the ratio of Y:X is between 1.1 to 3.0, preferably 1.2 to 2.0.

The object underlying the application is further achieved by a high-speed sintering process or a laser sintering process or a sintering process or a multi-jet fusion process for producing a molding by means of particle material application and selective solidification, the process comprising all further process steps and process means necessary for a 3D printing process, the process being carried out in a build area which is characterized by an X-axis and a Y-axis, forming the build area, and a Z-axis, wherein the size ratio Y>X>Z is present in the build area and/or wherein the ratio of Y:X is between 1.1 and 3.0, preferably 1.2 to 2.0.

The solution of the present disclosure has the advantage that the process times and printing cycles can be optimized and shortened, whereby the 3D printing process can be improved with respect to its cost-effectiveness compared to known high-speed sintering processes and/or laser sintering processes and/or sintering processes. In addition, improved temperature management can be achieved in the process according to the invention, which promotes advantages in terms of quality. In this way, the non-sintered, unbound particle material may also be conserved and recycled under certain circumstances.

Other preferred aspects and embodiments of the disclosure are disclosed in the subclaims.

The build area dimensions can be selected in accordance with the above. It may be advantageous if the dimension of the build field in the Y-direction is 50 cm and more and the build area dimension in the Z-direction is 50 cm and less, more preferably the dimension of the build field in the Y-direction is 60 cm and more and the build area dimension in the Z-direction is 40 cm and less.

Alternatively, it may be advantageous for the 3D printing device according to the disclosure to have a dimension of more than 50 cm for the X-axis of the build area, of more than 50 cm for the Y-axis, or/and of 50 cm and less for the Z-axis, preferably the X-axis is more than 55 cm, the Y-axis is more than 60 cm, and the Z-axis is 50 cm and less, particularly preferably the X-axis is 60 cm and more, the Y-axis is 100 cm and more, and the Z-axis is 40 cm and less.

In this case, it may be advantageous if the movable assemblies in the 3D printing device according to the disclosure are narrow, preferably with the recoater, the print head and/or the sintering emitter assembly being narrow in the X-direction, preferably in total smaller than the build field in the X-direction, particularly preferably smaller than 80% of the build field in the X-direction.

A 3D printing device according to the disclosure is configured with respect to the X-axis and Y-axis in accordance with the other design features, preferably with the recoater, print head and/or sintering emitter assembly extending substantially along the length Y and traveling along the X-axis.

In a 3D printing device according to the disclosure, it may be particularly advantageous if the printing modules and the print head are specially designed to achieve better heat distribution or/and better heat management. For instance, the printing modules of the print head can be arranged in a comb-like manner. This means that strips are first printed in one pass and parallel strips remain unprinted, with the previously unprinted strips then being printed in a second pass. Such a printing process may also be referred to as intermittent. This has the advantage that large areas can be printed using relatively short travel distances, thus saving time.

In the course of temperature management and temperature settings, it may be beneficial for advantageous printing results if further means for heat dissipation or heat regulation are provided. A 3D printing device according to the disclosure may comprise such means, wherein the 3D printing device comprises a means for heat dissipation, preferably wherein one or more or all of the heat-carrying elements are coupled with a coolant.

A 3D printing device according to the disclosure is preferably embodied wherein the means for heat dissipation is air or a gas or a gas mixture or a cooling liquid, e.g., oil-based, water or a water-based mixture, or a system of heat pipes.

It may be preferred in a 3D printing device according to the disclosure that the sintering assembly is cooled by air or a gas or a gas mixture or/and a cooling liquid or/and by means of heat pipes.

It may be preferred in a 3D printing device according to the disclosure that the sintering assembly is characterized by a closed air-cooling circuit and a liquid-based cooling circuit and wherein the air is circulated in the closed air-cooling circuit, preferably cooled by a ventilation means in the air-cooling circuit, or/and a cooling liquid or/and by means of heat pipes.

It may be preferred in a 3D printing device according to the disclosure that the liquid-based cooling circuit is arranged on the side facing away from the build field or/and is coupled with a further coolant, preferably an external coolant.

It may be preferred in a 3D printing apparatus according to the disclosure that the closed air-cooling circuit is at least partially guided past a radiation transducer, preferably wherein the air-cooling circuit is at least partially guided between two radiation transducers.

It may be preferred in a 3D printing device according to the disclosure that means for enlarging the surface area are arranged in the air-cooling circuit, preferably cooling ribs, cooling fins, cooling coils, or cooling helixes coupled to the liquid-based cooling circuit.

It may be preferred in a 3D printing device according to the disclosure that an IR emitter is disposed between a primary and secondary radiation transducer and the liquid-based cooling circuit, and optionally a reflector is disposed between the IR emitter and a liquid-flow cooling member.

It may be preferred in a 3D printing device according to the disclosure that the liquid-based cooling circuit is cooled by means of a liquid-flow cooling member on the outside of the sintering assembly, the cooling member preferably being a supporting lid.

It may be preferred in a 3D printing device according to the disclosure that cavities for the closed air-cooling circuit are located between the primary and secondary radiation transducers and between the primary radiation transducer and the supporting lid, preferably wherein surface enlargements of the liquid-flow cooling member are arranged therein, and optionally cavities are located in the side walls of the sintering assembly, all cavities communicating with each other to form a closed air-cooling circuit.

It may be preferred in a 3D printing device according to the disclosure that a reflector is disposed in the cavity between the primary radiation transducer and the supporting lid.

It may be preferred in a 3D printing device according to the disclosure that the closed air-cooling circuit has no connection to the ambient air.

It may be preferred in a 3D printing device according to the disclosure that the 3D printing device comprises one, two or more radiation transducers, preferably primary and/or secondary radiation transducers.

It may be preferred in a 3D printing device according to the disclosure that the 3D printing device comprises emitters of broadband electro-magnetic radiation of different wavelengths, the spectrum of which deviates from each other to a considerable extent, preferably long-wave IR emitters with a peak wavelength between 3 μm and 5.5 μm, combined with emitters with a peak wavelength in the short-wave infrared range between 0.7 μm and 2 μm,

or long-wave IR emitters combined with emitters of non-coherent electro-magnetic radiation with a narrow spectrum between 0.3 μm and 1.5 μm, preferably in the visible range,
or broadband medium-wave IR emitters in the range from 3 μm to 1.6 μm combined with short-wave IR emitters with peak wavelengths in the range from 0.7 μm to 1.6 μm. Any suitable emitter can be used, e.g. ceramic emitters, panel-type emitters, quartz halogen emitters, quartz tungsten emitters, heating conductors, quartz glass tubes, carbon emitters, near-infrared emitters, LED arrays with different wavelengths, gas discharge lamps, incandescent lamps, or/and heating wires can be employed.

It may be preferred in a 3D printing device according to the disclosure that the 3D printing device comprises an additional emitter assembly (emitter unit), wherein the emitter assembly is characterized in that it is an array of several emitters, wherein each emitter is individually controllable with regard to its temperature or a subset of emitters is combined into a group, wherein each group of emitters is controllable with regard to its temperature. It can also be advantageous to combine several emitters into a group, which are adjusted jointly with regard to their temperature.

It may be preferred in a 3D printing device according to the disclosure that a target temperature is set at each emitter or group of emitters, with the proviso that the power (watts) of the emitter is not set as a target parameter.

It may be preferred in a 3D printing device according to the disclosure that substantially each emitter or group of emitters in the emitter assembly (emitter unit) is set to a different target temperature.

It may be preferred in a 3D printing device according to the disclosure that the emitter assembly comprises a control circuit for target temperature adjustment of each emitter or/and for target temperature adjustment on the build field.

It may be preferred in a 3D printing device according to the disclosure that the emitter assembly uses an algorithm to achieve a target temperature on the build field by means of target temperature adjustment in the emitter assembly or/and wherein the target temperature adjustment is achieved by defining emitters as a subset of emitters combined to a group.

It may be preferred in a 3D printing device according to the disclosure that the emitter assembly comprises at least one thermographic camera directed at the build field and/or at least one infrared pyrometer and/or at least one temperature sensor, wherein the temperature sensor is preferably a thermocouple or a resistance thermometer. Preferably, the thermographic camera can be used for local measurement recordings and the infrared pyrometer for calibration of the absolute values.

It may be preferred in a 3D printing device according to the disclosure that the thermographic camera is used for local measurement recordings and the infrared pyrometer is used for calibration of the absolute temperature values.

It may be preferred in a 3D printing device according to the disclosure that it comprises an emitter assembly (emitter unit), wherein a target temperature on the build field is adjustable by a target temperature setting of each emitter in the emitter assembly.

In another aspect, the disclosure relates to a high-speed sintering process or laser sintering process or a sintering process or a multi-jet fusion process for producing a molding by means of particle material application and selective solidification, the process comprising all further process steps and process means necessary for a 3D printing process, the process being carried out in a build area which is characterized by an X-axis and a Y-axis forming the build area and a Z-axis, wherein the size ratio Y>X>Z is present in the build area and/or wherein the ratio of Y:X is between 1.1 and 3.0, preferably 1.2 to 2.0.

In the device and process according to the disclosure, it may be further preferred that a feed container is included or used in the device.

In such a process, advantageously, the features of the above-described 3D printing devices according to the disclosure may likewise be used, and thus an advantageous process according to the disclosure is characterized by any feature or combination of the features of the device or of the device claims.

In particular, a process may be preferred wherein the process is carried out in a build area characterized in that the recoater extends substantially along the length Y and is moved in the X-direction.

Furthermore, a process according to the disclosure may be preferred and advantageous, wherein said process is performed using a device, wherein the recoater, the print head and/or the sintering emitter assembly are narrow in the X-direction, preferably in total smaller than the build field in the X-direction, particularly preferably smaller than 80% of the build field in the X-direction.

Furthermore, a process according to the disclosure may be preferred and advantageous, wherein said process is performed using a device, wherein the recoater, the print head and/or the sintering emitter assembly substantially extend over the length Y and/or are moved along the X-axis.

Furthermore, a process according to the disclosure may be preferred and advantageous, wherein said process is performed using a device, wherein the printing modules of the print head are arranged in a comb-like manner.

Furthermore, a process according to the disclosure may be preferred and advantageous, wherein the process is performed using a device, wherein the 3D printing device comprises a means for heat dissipation, preferably wherein one or more or all of the heat-carrying elements are coupled with a coolant.

Furthermore, a process according to the disclosure may be preferred and advantageous, wherein the process is performed using a device, wherein the means for heat dissipation is air or a gas or a gas mixture or a cooling liquid, e.g., oil-based, water or a water-based mixture, or a system of heat pipes.

Furthermore, a process according to the disclosure may be preferred and advantageous, wherein the process is performed using a device, comprising a sintering assembly, wherein the sintering assembly is cooled by air or a gas or a gas mixture or/and a cooling liquid or/and with the help of heat pipes.

Furthermore, a process according to the disclosure may be preferred and advantageous, wherein the 3D printing device comprises one, two or more radiation transducers, preferably primary and/or secondary radiation transducers.

Furthermore, a process according to the disclosure may be preferred and advantageous, wherein the 3D printing device comprises emitters of broadband electro-magnetic radiation of different wavelengths, the spectrum of which deviates from each other to a considerable extent, preferably long-wave IR emitters with a peak wavelength between 3 μm and 5.5 μm, combined with emitters with a peak wavelength in the short-wave infrared range between 0.7 μm and 2 μm,

or long-wave IR emitters combined with emitters of non-coherent electro-magnetic radiation with a narrow spectrum between 0.3 μm and 1.5 μm, preferably in the visible range,
or broadband medium-wave IR emitters in the range from 3 μm to 1.6 μm combined with short-wave IR emitters with peak wavelengths in the range from 0.7 μm to 1.6 μm.

In the device and process according to the disclosure, it may be further preferred that the device comprises or uses a feed container.

Further aspects of the disclosure and further exemplary description of the disclosure

Various aspects of the disclosure will be described below by way of example and should not be construed as restrictive. Also, any aspect from the example Figures shown below can be made usable in any combination.

In general, the build area of a 3D printing machine can be separated into two areas, namely the two-dimensional build field (X- and Y-axis) and the Z-axis.

The design of the build field focuses on the use of Cartesian coordinates for selective printing. For this reason, essentially square or rectangular build fields are found in prior art systems. In the literature, there are also build fields that work with cylindrical coordinates. However, the implementation in practice is difficult, since most of the parts to be printed can be described more easily with Cartesian coordinates than with cylindrical coordinates, and therefore the conversion as well as the optimization of the build field utilization is more difficult.

In the case of the high-speed sintering process in 3D printing, there is also the fact that temperature management on the build field works via emitters, and these tend to be available in line or surface form. In this respect, a build field in a high-speed sintering plant will also tend to have a square or rectangular shape. This also essentially applies to the other 3D printing processes mentioned above and is also to be understood in this way for the following explanations.

In addition, the build field is to be selectively printed with an absorber. This is usually done using print heads that operate according to the DOD (drop-on-demand) principle. Such print heads have an array of nozzles that can be controlled individually. To print a complete image with absorber, such print heads are guided over the build field on one or two axes, depending on the number of nozzles and the area to be printed. It is important that the absorber is applied to all printed areas with approximately the same resolution. This is also easier to represent with Cartesian movement of the print head using linear axes than when using cylindrical coordinates.

The layout of the build field may vary. A distinction can be made between square or rectangular build fields. The comparison is to be made with the same build surface. Optimization here takes place in the sense of a low process time.

It should be noted that in the high-speed sintering process, each layer is produced by the three operations of coating, printing and sintering, and for each of these three operations, different assemblies must be guided over the entire build field. In principle, the assemblies can be moved via different or combined axis systems, depending on the design.

Coating is carried out by a linear recoater, which is moved on an axis over the build area at a uniform speed, applying a new layer to the build field. The coating speed depends on the design of the recoater and typically ranges from 80 mm/s to 400 mm/s.

Sintering is in turn carried out by means of a radiation source, which is also typically line-shaped and also extends over an entire side of the build field. The radiation source should be moved across the build field at a uniform speed transverse to the linear propagation direction like the recoater. Depending on the power of the lamp and the material to be processed, speeds of 80 mm/s to 400 mm/s also result.

Due to the similar requirements with regard to movement, the emitter can be moved coupled with the recoater. In this case, sintering and coating can take place simultaneously. However, it is also possible for the coating to occur when the coupled coating/sintering unit is moving in one direction and for the sintering process to occur when the unit is moving in the other direction.

The absorber is printed by means of a print head, which usually works according to the DOD principle. For reasons of printing speed, several printing modules, which combine individually controllable nozzles to form a nozzle array, are combined for this purpose.

The print head, which is composed of one or more such arrays, is then moved over the build field either in a meandering pattern or only along one axis, depending on the embodiment. The latter is possible if the print head extends over an entire side of the build field and has the desired resolution in that direction. If the print head is narrower, it must be guided several times over the build field and shifted in between at right angles to the direction of travel.

Ina preferred embodiment, the print head is provided with nozzle arrays in a comb-shaped manner so that it spans the entire side of a build field, but must be shifted once transversely to it to print on the entire build field in two passes. Here, with only two passes, the transverse movement of the print head is minimized.

The printing speed is typically 300-600 mm/s, which is faster than the coating or sintering speed. Typically, the timing of the printing movement can be at least partially integrated into the coating/sintering process via a clever arrangement of the print head and its axes of movement.

When considering the layer time tₘᵢₙ, it must be taken into account that the assemblies attached to the respective axes have an extension in the direction of movement, which must be included in the calculation because the assemblies sweep the build field surface in its entirety and must provide space at their reversal points for assemblies of the opposite axis. Furthermore, an acceleration and deceleration ramp must be taken into account. These additional travel lengths on both sides of the build field will be called overrun in the following. Since the coating application is the slowest movement in the production process of the moldings, it is preferable to select a rather short travel length for the recoater and to make all assemblies as narrow as possible in the coating direction in order to minimize the overrun.

Assuming a square build field, the overrun is added to both sides of the recoater's travel, so it is easy to see that a rectangular build field coated over its short side can be processed in less time.

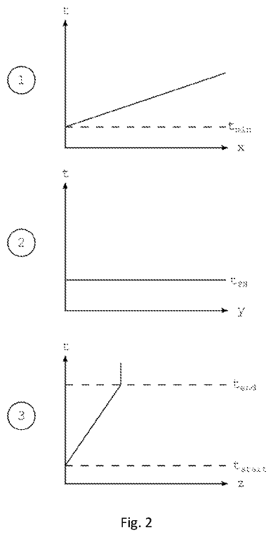

The dimension transverse to the recoater travel direction, on the other hand, is negligible with regard to the time loss, as shown in FIG. 2 (2), as long as scaling of the printing unit used also takes place. However, a minimum time for moving and positioning the print head is necessary. If the printing unit is not as wide as the build field, a positioning time must be added to this time t_{PH}, but this is usually less than the time lost in the coating direction, since the repositioning speed is not subject to any process-related limitations other than mechanical stress.

However, in terms of temperature management during the building process, square build fields are usually more suitable than rectangular build fields because the edge effects are less marked.

From the above two considerations, a build field optimized for high-speed sintering processes or any other 3D printing process mentioned herein in terms of process time tends to be rectangular in shape, and the form factor as the ratio of long to short side of the rectangle should be relatively small, in the range of 1.2 to 2, so as to limit edge effects.

In the layering direction of FIG. 2 (3), denoted here by Z, the total process duration is linearly related to the Z-dimension. That is, doubling the Z-dimension also means doubling the total process time. The feed rate in the Z-direction is defined by the time of an entire layer cycle and also scales with the thickness of a layer. Added to the feed time are tₛₜₐᵣₜ and t_{end}, which result from the fact that the entire device has to be heated up and the particle material cake has to be cooled down before the produced moldings can be removed. To these times must be added the time required to create start and end layers, to thermally insulate the moldings from the environment and, in the case of the start layers, to achieve a temperature and control equilibrium. Compared to the effect of the other two dimensions on build time, the Z-dimension enters most strongly into this consideration. This is because, unlike the Z-dimension, the length of the build field in the coating direction also enters linearly into the determination of the build time, but with a lower factor. Doubling the length in the coating direction also results in an increase in build time. Due to the additional traversing lengths along this axis, which are independent of the dimensional change, the build time extension will be less than a factor of 2. An enlargement of the build field transverse to the coating direction has no effect on the build time if the print head is scaled up at the same time.

Under these aspects, the Z-dimension is the most critical dimension in the Cartesian build area and should be chosen smallest of the three dimensions in order to reduce the build time as much as possible. The lower reasonable limit is defined by the range of parts to be built. The advantage of the Z-dimension, however, is that it can be selected variably with each job and only the maximum size is defined by the system.

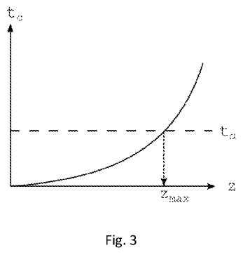

The graph in FIG. 3 does not refer to the direct generation time of a molding, but to the cooling time t_{c}, which is important for removal. For illustration purposes, the X and Y dimensions are assumed to be constant here.

The cooling time of the powder cake can be calculated using the differential equations for heat conduction via the finite element method. The spatio-temporal evolution of the temperature field T (x, y, z, t) is given by the relation:

$$\frac{ρ c}{λ} \frac{\partial T}{\partial t} = \frac{{\partial }^{2} T}{\partial {x}^{2}} + \frac{{\partial }^{2} T}{\partial {y}^{2}} + \frac{{\partial }^{2} T}{\partial {z}^{2}}$$

where ρ is the density of the material, c is the heat capacity, and λ is the thermal conductivity. The change in heat flow through the boundary surfaces A of the volume, measured in W/m², depends on the differential temperature of the two boundary surfaces T_{W} to T_{∞}, as well as on the heat transfer coefficient α:

$$\dot{q} = α \cdot ( {T}_{W} - {T}_{∞} ) = \frac{\dot{Q}}{A}$$

Especially on the surface of the powder cake, the coupling of heat transfer to the environment via thermal radiation takes place according to Stefan-Boltzmann's law:

\dot{q}=∈(T)·σ·A·T⁴

The so-called T⁴ law is based on the size of the surface A, the temperature-dependent emissivity ε(T) and the Stefan-Boltzmann constant σ.

Clearly, there is a nonlinear relationship of the cooling time when there is a linear increase in volume. The reason for this is the small thermal conductivity A of the particle material used and that the heat transfer can take place maximally at the surfaces of the particle material volume, but these increase to a lesser extent as the volume increases. In addition, the amount of heat content also scales with the volume. Thus, several advantages result from keeping at least one dimension of a cuboid particle material cake small. It is also advantageous to design a further dimension that is smaller than the last. Above a critical limit, denoted here by zₘₐₓ, there is a cooling time for the particle material cake that is greater than the degradation time t_{d} of the particle material. This means that losses in the mechanical properties of the moldings produced must be expected, and the unprinted particle material furthermore cannot be fed back to the layering process. Irrespective of this, a long cooling time before the produced moldings can be removed is not desirable for productive operation. The length of the cooling time in relation to the build time also increases the number of job boxes required, since the system can advantageously be loaded with a new job box after printing and then print another job. Furthermore, the cooling time should not be significantly longer than 24 hours in order to be able to achieve a balanced utilization of the operators with one system in single-shift operation.

FIG. 2 graphically shows the influence of each dimension of the process field on the processing speed in additive manufacturing using the high-speed sintering process.

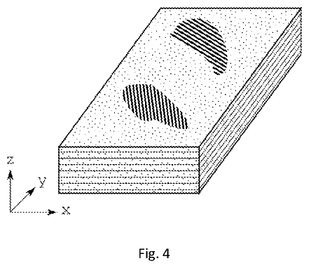

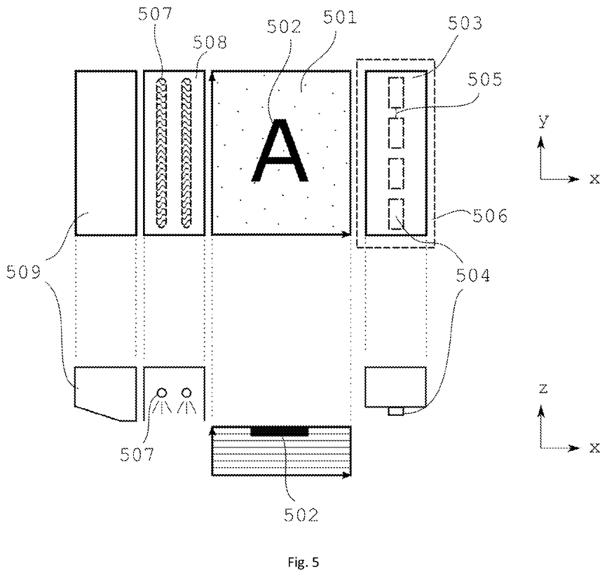

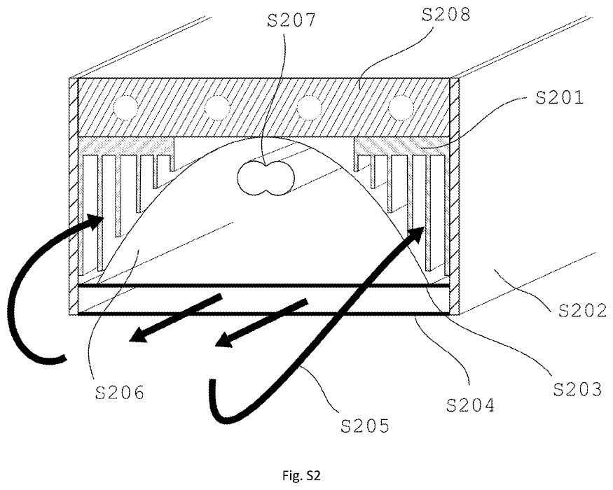

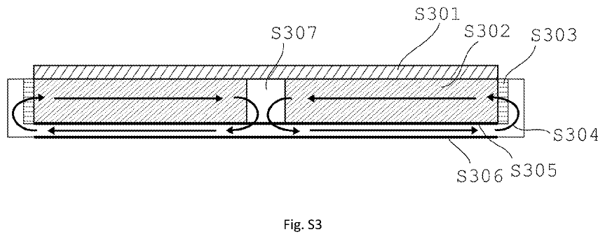

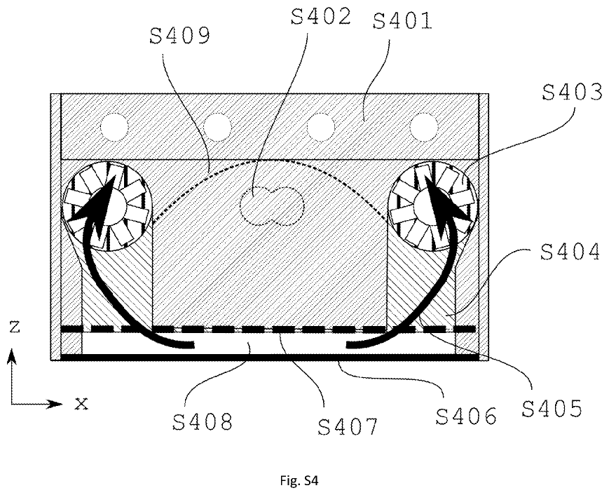

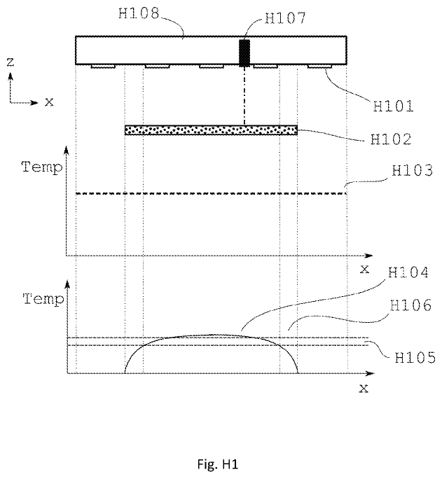

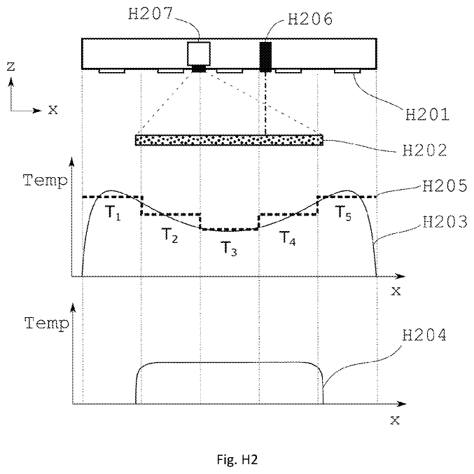

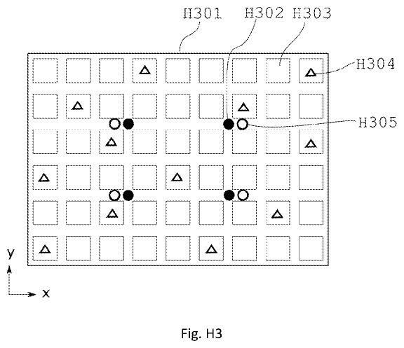

Thus, in the overall view, a preferred dimensional ratio of Y>X>Z results as schematically illustrated in FIG. 4. The individual layers of the building process are shown, as are the molding sections created on the surface. Standard market dimensions for plastic moldings can be up to 1 meter in one direction. Since this market is to be served in the additive manufacturing process using, for example, the high-speed sintering process, a process field size of this order of magnitude seems reasonable, at least in one spatial dimension. Following these considerations, this dimension can be called Y for consistent naming. This results in a range of <1 meter for the X dimension. Furthermore, again following the paradigm of productivity, the Z direction should be the smallest. However, it should also be smaller than zₘₐₓ, which results in a value between 150 and 400 mm when using a commercially available particle material such as Voxeljet HSS PA12 Powder Type B or HSS PP Powder Type A. The reason for this is the low removal temperature of approx. 40° C. compared to the processing temperature of 170° C., or 130° C. for high-speed sintering processes using PP Powder Type A. This value in the Z-direction also depends on the expansion in the X-direction, which is limited by the fact that X>Z should apply.

According to the disclosure it may be useful and advantageous, in one aspect, to combine the above-described build area design and geometry, which may be defined by the X, Y, and Z axes, with further means, for example, to provide or support improved heat dissipation. Likewise, in one aspect, it may be useful to design the sintering assembly in a particular way that then positively impacts the build area design and results in further device improvement and process flow improvement in concert with the build area design.

The shape of the sintering assembly results from the considerations with regard to the build field geometry. In order to minimize the time lost in the X-direction when the sintering assembly sweeps over the process field as well as minimize the reversal distance included therein, the shape requirement is for the assembly to be as narrow as possible in the X-direction. However, a long and relatively narrow sintering device poses special challenges in terms of temperature management, which can only be met by means of a special type of design. Due to the large footprint of the assembly, the amount of heat generated by secondary effects on the emitter unit and the absorbed spectrum from the two spectrum converters can no longer be accounted for by the conventional cooling device with fluid-flowing device lid. The result is overheating of the spectrum converters, which in turn would cause unwanted secondary radiation or a considerably shortened lifetime of the emitter unit.

This can only be countered by improving the coupling between generated and dissipated heat. The amount of heat cannot simply be transported out of the assembly by, for example, air cooling by means of an attached fan, as this would result in contamination of the assembly's space, and the supply and removal of air is made difficult by the fact that the device is in constant motion and performs several thousand cycles of sweeping the process field during a single building process.

This problem can be solved by using an emitter assembly that couples all heat-supplying elements with a coolant via a closed air circulation system. The air circulation can be generated, for example, by fans and/or the supply of compressed air and the use of diffusers.

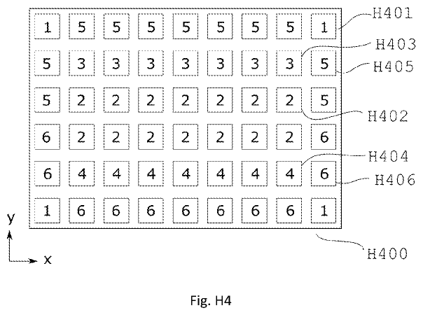

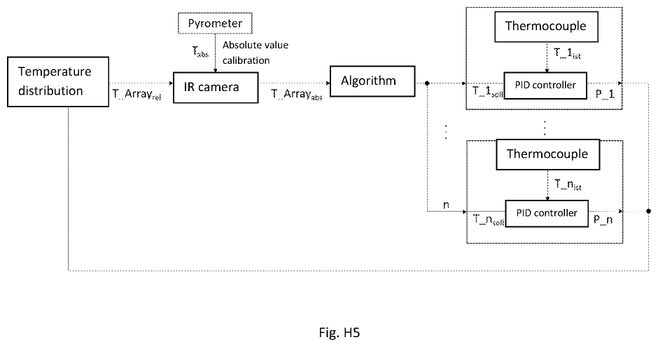

An exemplary concept of a device for additive manufacturing according to a high-speed sintering process resulting from the considerations on the dimensional ratio of the process field is described in FIG. 5. It shows the view from above (XY plane), as well as from the front (XZ plane). In one embodiment example, the build area has the dimensions 600×1000×400 mm³.

In one embodiment example, the sintering assembly is described according to the disclosure and advantageously in combination with the disclosure for build area design, being equipped by means of a self-contained air circulation S205, as schematically illustrated in FIG. S2 shown in section through the device in the XZ plane. The air in the assembly is directed through the cavity between the spectrum converters S203, S204 and past cooling ribs S201, which are connected to the cooling lid. This allows a strong increase in the efficiency of heat dissipation made possible by the lid through which water flows. In addition, the continuous airflow dissipates heat more evenly, which benefits the local continuity of the emitted radiation spectrum.

The sintering assembly in the side view (YZ plane) with an illustrated airflow in FIG. S3 exhibits a recess S307 on the side walls through which the cooling air is passed. This ensures that the spectrum converter is sufficiently cooled at its hottest point, since it is furthest away from heat-conducting components. The air flow S304 is generated and maintained by fans S303. What is clearly visible is the important aspect that the continuous airflow circulates in a sealed housing. Thus, the emitter assembly, although having high power and an adapted spectrum, can also be operated in environments with a high risk of contamination, e.g. by dust.

It may further be useful to combine an emitter assembly for build field temperature control with the build area geometry and dimensions described above, depending on the specific requirements of the 3D printing device and its required design specifications.

This additionally allows optimization of the field temperature control.

Accordingly, different emitter powers can be used to compensate for the inhomogeneous temperature distribution on the object surface H202, as shown in FIG. H2. In this case, individual infrared emitters H201 at the peripheral areas of the emitter assembly are combined to form dedicated heating circuits, which are operated at a higher power compared to those in the center of the assembly. In this example, 5 different surface temperatures H205 of the panel-type infrared emitters H201 are outlined. The surface temperatures are approximated as closely as possible to the location-dependent heating curve H205 previously calculated from geometric and physical considerations. The result is a relatively homogeneous temperature field H204 on the object surface. For a control of the resulting temperatures, an infrared pyrometer H206 is used again, but this time coupled with a thermographic camera H207, which is able to record the temperature distribution of the object surface with spatial resolution.

The measurement data from the thermographic camera can now be used to control the individual panel-type emitters in a targeted manner and thus compensate for non-uniformity in the local constancy of the object surface temperatures, which includes their peripheral areas in particular. Each individual emitter is assigned a corresponding area element on the object surface. In one embodiment example, the infrared pyrometer is used for absolute value correction, thus guaranteeing that a temperature drift is prevented in the measurements of the thermographic camera and ensuring temporal constancy of the temperature field.

As in the assembly (H301) of individual emitters (H303) shown in FIG. H3, control by thermographic camera (H302) and infrared pyrometer (H305) does not simply adjust the power at the individual heating elements. Instead, the temperature of the individual heating elements is measured by means of a temperature sensor (H304), which is integrated into the heating elements, and fed to a control system as a measured value. If the control system is designed as a PID controller, it can be used to minimize the time required for the emitters to reach the target temperature. The prerequisite for this is that sufficient reserve has been given to the heating power of the individual heating elements. For example, an emitter can be used whose maximum power is 650 watts, but the emitter temperature to be reached at equilibrium is already reached at 200 watts. The controller is then able to maximize the set power until the target temperature is reached, only to reduce it back to the steady-state condition within a short period of time when the target temperature is reached. The response time can thus be reduced to well below 20 sec, which is within the layer cycle time of a sinter printer. Thus, it is now possible for the system to react in time to temperature fluctuations.

Furthermore, this process can greatly reduce the lengthy heating time until the steady state is reached to as little as a quarter.

In an exemplary arrangement of an emitter assembly there are 4 thermographic cameras H302 and infrared pyrometers H305 each, in order to enable contactless object surface temperature measurements with the smallest possible angular error and to keep the distance between the assembly and the object surface small. A smaller distance results in higher energy efficiency. H304 are conventional temperature sensors, e.g. thermocouples or resistance thermometers, which continuously measure the surface temperature of the infrared emitters, and due to the Stefan-Boltzmann law therefore the radiated power, and together with the other two measuring devices give the input values for the setpoint control. The target temperature of the individual heating elements is calculated using the following relationship:

\dot{Q}₁₂=C₁₂·(T₁⁴−T₂⁴)

C₁₂=ε₁·ε₂·F₁₂

The heat flow \dot{Q}₁₂ between the emitter and the corresponding build field element with temperature T₁ should be minimized by adjusting its temperature T₂. In addition to the emission factors of the emitter ε₂ and the particle material on the build field ε₁, the so-called view factors F₁₂ and F₂₁ are decisive. The view factors describe the orientation of both surfaces with respect to each other, where F₂₁ denotes the radiation flux from the emitter to the build field and F₁₂ denotes the reverse path. The solution of the target temperatures for each heating element can be achieved by solving the system of resulting differential equations using the finite element method.

If a larger surface is to be covered, several emitter fields can be staggered, i.e. arranged in combination, without any problems. By overlapping the measurement ranges of thermographic cameras and infrared pyrometers, calibration data can further be generated and thus the measurement accuracy of the instruments used can be improved by comparing the measurement data obtained. Thus, almost any build field geometries and sizes are possible without including another complex and costly design step.

Based on symmetry considerations, in one embodiment according to the disclosure, as shown in FIG. H4, groups of emitters of the emitter assembly (H400) can be formed, i.e. (H401) to (H406), each of which can be controlled together. Thus, effort and costs can be saved without major restrictions in the temperature constancy on the object surface and the control algorithm is simpler. Hence, it makes sense to consider emitters (H401) separately at the 2nd order discontinuities, i.e. the corners of the object surface to be heated, since a stronger heat flow can be expected there due to the cooler environment. The situation is similar when considering the edges (H405) and (H406) of the object surface to be heated, which are separated to compensate for differences between the front and back of the device. (H203) and (H204) perform this for the interior area. The center of maximum symmetry in the middle of the assembly is then covered by (H402). Combining several individual emitters can also have a beneficial effect on measurement accuracy. For example, several temperature sensors can be evaluated within a group, using averaging to level out manufacturing tolerances.

Furthermore, FIG. H5 schematically shows an embodiment of a corresponding control as it can be applied in the embodiment examples shown in FIG. H3 and FIG. H4. Variations in the temperature distribution on the object surface are measured by means of a thermographic camera. An area element is also covered by an infrared pyrometer. The temperatures of this area element measured by the thermographic camera are averaged and compared with the value measured by the pyrometer. The camera is then readjusted until these two values are equal. Subsequently, the obtained correction factor is applied to the rest of the measured data. The corrected data is then transferred to the control systems of the heating elements via an algorithm. The algorithm has the task of assigning a corresponding area element to each individual emitter. In addition, the overlap of the area elements is taken into account here. The reason for this is that the individual emitter also reaches adjacent area elements due to the radiation cone formed. In addition, the algorithm must take into account the geometric arrangement of the individual emitters, because adjacent emitters influence each other. In the worst case, this could lead to an unwanted oscillation of the outputs of the individual heating circuits over time.

The algorithm calculates target temperatures of the individual heating elements and sends them to the controllers of each heating circuit. The controllers, exemplified by conventional PID controllers, compare target temperature values and actual temperature values and ensure that the specified target temperature of the infrared emitters is reached in as little time and with as little deviation as possible by controlling the electrical power supplied to these emitters.

Next, the temperature distribution is measured again and the process starts anew. Preferably, one cycle run of the entire control system takes place at a defined time per layer cycle of the building process, so that the measurement is not impeded by units such as the sintering device, recoater and print head, which move over the build field surface during this time.

FIG. H5 schematically shows an embodiment of a control according to the disclosure, wherein variations in the temperature distribution on the object surface are measured by means of a thermographic camera and temporal variations are compensated for by means of an infrared pyrometer, and the absolute temperature value can be calibrated. The obtained measurement data are fed to an algorithm that uses them to calculate the target temperatures of each infrared emitter and passes them on to the PID controllers.

Furthermore, FIG. H5 schematically shows an embodiment of a corresponding control as it can be applied in the embodiment examples in FIG. H3 and FIG. H4.

The solver algorithm, which serves the task of calculating the target temperatures of the individual heating elements, does so on the basis of physical relationships that describe the heat flow. The view factors F_{y} represent an important component here.

The view factors describe the orientation of both surfaces with respect to each other, where F₂₁ denotes the radiation flux from the emitter to the build field and F₁₂ denotes the reverse path. The view factors of two finite faces opposite each other have the general form

$${F}_{ij} = \frac{1}{{A}_{i}} {\int }_{{A}_{i}} {\int }_{{A}_{j}} \frac{cos {θ}_{i} cos {θ}_{j}}{π {R}_{ij}^{2}} d {A}_{i} d {A}_{j}$$

The view factor Fᵢⱼ is thus defined by the finite opposing surfaces Aᵢ and Aⱼ of the emitter and the build field, respectively, as well as their respective angles to the unit normals to these, cos Θᵢ and cos Θⱼ, and the distance of the surfaces to each other RV.

In this regard, an emitter unit according to the disclosure may be designed in such a way that an emitter illuminates not only an area element, i.e., an area (subarea) of the build field, but the entire build field. Thereby, the main radiation is projected onto a core area (area element) and furthermore, radiation also impinges around this core area. Likewise, each area element of the entire build field exchanges radiation with the emitter or the emitter assembly. This now applies to each individual emitter in the emitter unit. The geometrical arrangement of emitters, such as their size, distance to the build field and distance to each other, is described by means of the above-mentioned view factors, as is the geometry of the build field to be heated, i.e. its orientation, length and width.

Since it is known which materials are used, their mostly temperature-dependent emissivity can be taken into account during design and operation, i.e. when performing a 3D printing process.

In addition, heat flows due to convection and conduction in the particle material and in the emitter assembly, which in turn are temperature dependent, are included in the calculation for the design and operation of an emitter assembly according to the disclosure. This applies in particular to the peripheral areas of the build field and of the emitter assembly, since convection and heat conduction occur more frequently here due to the discontinuity. Furthermore, additional heat conduction can be considered due to the location of the emitter assembly and the coolants required for shielding from the machine housing.

Thus, a complex set of dependent inhomogeneous differential equations results. The task of a solver algorithm is now to solve this system of equations by determining the eigenvalues of the temperatures assigned to the radiant heaters on the basis of the input of the measured temperature values in such a way that the calculated total heat flow \dot{Q}_{ges} between the emitters and the build field is minimized by including the build field set temperature.

The solution of these target temperatures (T_n,soll) for each emitter n can be achieved by solving the system of equations by means of a solver using the finite element process. Such a solver can complete the calculations within the time of one layer cycle due to advances in the computing power of modem computer systems and optimizations in the individual calculation steps.

The target values calculated for the individual emitters are now transferred to a set of controllers, which have the task of setting these target temperatures at the emitters in the shortest possible time.

The controllers, exemplarily designed as conventional PID controllers, compare the target temperature value and the actual temperature value (T_n,ist) and ensure that the specified target temperature of the emitters (e.g. infrared emitters) is reached in the shortest possible time and with the smallest possible deviation by controlling the electrical power (P_n) supplied to these emitters via the variation of the applied average voltage.

Once the target temperature has been reached at the emitters, the temperature distribution is then measured again. By comparing the measured values with the calculated values, correction factors are now derived which will be included in future calculations. Thus, the system is able to respond dynamically to manufacturing tolerances in the structure and to disturbances, such as a change in the environmental condition or changes in the composition of the particle material, for example due to the aging of portions of recycled material added to the printing process. Aging phenomena of the device itself are also automatically corrected. A run-in of the 3D printer over several weeks as usual in the prior art is also avoided.

Preferably, one cycle run of the entire control system takes place at a defined time per layer cycle of the building process, so that the measurement is not impeded by units such as the sintering device, recoater and print head, which move over the build field surface during this time. Changes in the interaction with the radiation field or changes in the temperature of the assemblies used in the layering process no longer have an effect, since the shading of the build field can be masked out depending on time and place.

This has the advantage that, in contrast to the prior art, no adjustment and/or calibration of the device is necessary. Furthermore, the 3D printer is capable of stable operation even under fluctuating environmental conditions, which thus includes operation in areas with higher or lower ambient temperatures. This leads to a cost advantage, as it eliminates costs for e.g. ambient air conditioning.

During the printing process, the sintering process of the particle material surfaces wetted with IR acceptor (IR absorber), which correspond to the cross-section of a molded article to be produced, introduces additional energy by means of a sintering unit, which leads to an increase in temperature there. Furthermore, the already created molded article parts change physical parameters such as the thermal conductivity in the particle material or also the emissivity of the printed surface. In prior art devices, this repeatedly leads to abortions of the printing process due to uncontrollable process conditions and even damage to the machine.

In the present case, the position of the parts in the build area is known. Thus, the sectional view data for the application of the IR acceptor is already available and can be fed to and taken into account by the solver algorithm. The latter is now able to react dynamically to different degrees of filling of the particle material surface. In principle, it is also possible to use this process to automatically place the molded articles in the build area in a process-optimized manner. This eliminates the time-consuming and complex step of manually arranging the molded articles to be generated in the virtual build area. This results in major time and cost savings. For example, there is no need for the training in parts placement and fine adjustment required to operate sintering machines. In the prior art, in order to ensure optimal orientation and parameterization, molded articles are often created several times, which is known in the art as so-called “ghost jobs”. The elimination of these multiple pre-test prints leads to a significant reduction in manufacturing costs.

In addition, the required repeatability, which is important for industrial production, can be achieved so that tighter tolerances can be applied to the molded articles produced. Thus, an increase in quality is also achieved.

If a larger surface is to be covered, several emitter fields (overlapping fields covered by a group of emitters or by different emitter units) can easily be staggered. By overlapping the measurement ranges of thermographic cameras and infrared pyrometers, calibration data can further be generated and thus the measurement accuracy of the instruments used can be improved by comparing the measurement data obtained. Thus, almost any build field geometries and sizes are possible without including another complex and costly design step.

### LIST OF REFERENCE NUMERALS

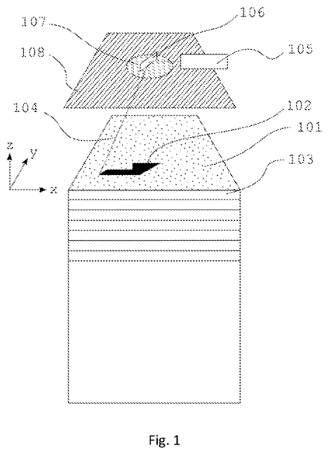

FIG. 1

| | |
|---|---|
| 101 | square particle material surface |
| 102 | molding |
| 103 | one layer of particle material |
| 104 | laser beam |
| 105 | laser generation |
| 106 | deflecting mirror |
| 107 | protective glass and, if necessary, lens system |
| 108 | top of build area |

FIG. 5

| | |
|---|---|
| 501 | build field surface |
| 502 | molding |
| 503 | print head with printing modules arranged in a comb-like manner |
| | over the total width of the build field in Y-direction |
| 504 | single printing module |
| 505 | clearance between printing modules requires only a slight move- |
| | ment of the print head in the Y-direction when moving back and |
| | forth over the build field surface in order to wet it completely |
| | and without gaps. |
| 506 | device arranged underneath for cleaning the printing modules |
| | during coating |
| 507 | single sintering emitter |
| 508 | sintering emitter assembly |
| 509 | recoater unit |

FIG. S2

| | |
|---|---|
| S201 | cooling ribs |
| S202 | side walls |
| S203 | primary spectrum converter |
| S204 | secondary spectrum converter |
| S205 | air flow through the cooling ribs |
| S206 | reflector |
| S207 | emitter |
| S208 | supporting lid, through which cooling fluid flows |

FIG. S3

| | |
|---|---|
| S301 | supporting lid, through which cooling fluid flows |
| S302 | cavity above reflector equipped with cooling ribs |
| S303 | fan |
| S304 | air flow |
| S305 | primary radiation transducer |
| S306 | secondary radiation transducer |
| S307 | air flow through recess in the side wall in the center of the |
| | assembly |

FIG. S4

| | |
|---|---|
| S401 | supporting lid, through which cooling fluid flows |
| S402 | emitter |
| S403 | fan |
| S404 | cavity in short side walls of the short side for air flow |
| S405 | air flow |
| S406 | secondary radiation transducer |
| S407 | primary radiation transducer |
| S408 | cavity between both radiation transducers |
| S409 | reflector |

FIG. H1

| | |
|---|---|
| H101 | infrared emitter |
| H102 | object surface |
| H103 | temperature of the infrared emitters in the X-direction |
| H104 | resulting temperature distribution on the object surface |
| H105 | optimal temperature range |
| H106 | area along the X-direction that is below the optimal temperature |
| H107 | infrared pyrometer |
| H108 | infrared emitter assembly |

FIG. H2

| | |
|---|---|
| H201 | infrared emitter |
| H202 | object surface |
| H203 | calculated required temperature of the infrared emitters in the |
| | X-direction |
| H204 | resulting temperature distribution on the object surface |
| H205 | discretization of the required surface temperature and |
| | calculation of the power setting for the individual infrared |
| | emitters |
| H206 | infrared pyrometer |
| H207 | thermographic camera |

FIG. H3

| | |
|---|---|
| H301 | emitter assembly |
| H302 | thermographic camera |
| H303 | infrared emitter |
| H304 | temperature sensor |
| H305 | infrared pyrometer |

FIG. H4

| | |
|---|---|
| H400 | emitter assembly |
| H401-H406 | infrared emitters grouped into individual heating circuits |

1. A 3D printing device for use in a high-speed sintering process or a laser sintering process or a sintering process or a multi-jet fusion process, characterized in that the build area is characterized by an X-axis and a Y-axis, forming the build field, and a Z-axis, wherein the size ratio Y>X>Z is present in the build area and/or wherein the ratio of Y:X is between 1.1 to 3.0, preferably 1.2 to 2.0.

2. The 3D printing device according to claim 1, wherein the recoater extends substantially along the length Y and is moved in the X-direction, or/and
wherein the dimension of the build field in the Y-direction is 50 cm and more and the build area dimension in the Z-direction is 50 cm and less, more preferably the dimension of the build field in the Y-direction is 60 cm and more and the build area dimension in the Z-direction is 40 cm and less, or/and
wherein the recoater, the print head and/or the sintering emitter assembly are narrow in the X-direction, preferably in total smaller than the build field in the X-direction, particularly preferably smaller than 80% of the build field in the X-direction, or/and
wherein the recoater, print head and/or sintering emitter assembly extend substantially along the length Y and travel along the X-axis, or/and
wherein the printing modules of the print head are arranged in a comb-like manner, or/and
wherein the 3D printing device comprises a means for heat dissipation, preferably wherein one or more or all of the heat-carrying elements are coupled with a coolant, or/and
wherein the means for heat dissipation is air or a gas or a gas mixture or a cooling liquid, e.g., oil-based, water or a water-based mixture, or a system of heat pipes, or/and
wherein the sintering assembly is cooled by air or a gas or a gas mixture or/and a cooling liquid or/and by means of heat pipes, or/and
wherein the sintering assembly is characterized by a closed air-cooling circuit and a liquid-based cooling circuit and wherein the air, or a gas or a gas mixture is circulated in the closed air-cooling circuit, preferably cooled by a ventilation means in the air-cooling circuit, or/and a cooling liquid or/and by means of heat pipes, or/and
wherein the liquid-based cooling circuit is arranged on the side facing away from the build field or/and is coupled with a further coolant, preferably an external coolant, or/and wherein the closed air-cooling circuit is at least partially guided past a radiation transducer, preferably wherein the air-cooling circuit is at least partially guided between two radiation transducers, or/and
wherein means for enlarging the surface area are arranged in the air-cooling circuit, preferably cooling ribs, cooling fins, cooling coils, or cooling helixes coupled to the liquid-based cooling circuit, or/and
wherein an IR emitter is disposed between a primary and secondary radiation transducer and the liquid-based cooling circuit, and optionally a reflector is disposed between the IR emitter and a liquid-flow cooling member, or/and
wherein the liquid-based cooling circuit is cooled by means of a liquid-flow cooling member on the outside of the sintering assembly, the cooling member preferably being a supporting lid, or/and
wherein cavities for the closed air-cooling circuit are located between the primary and secondary radiation transducers and between the primary radiation transducer and the supporting lid, preferably wherein surface enlargements of the liquid-flow cooling member are arranged therein, and optionally cavities are located in the side walls of the sintering assembly, all cavities communicating with each other to form a closed air-cooling circuit, or/and
wherein a reflector is disposed in the cavity between the primary radiation transducer and the supporting lid, or/and
wherein the closed air-cooling circuit has no connection to the ambient air, or/and
wherein the 3D printing device comprises one, two or more radiation transducers, preferably primary and/or secondary radiation transducers.

3. The 3D printing device according to claim 2, wherein the 3D printing device comprises emitters of broadband electro-magnetic radiation of different wavelengths, the spectrum of which deviates from each other to a considerable extent, preferably long-wave IR emitters with a peak wavelength between 3 μm and 5.5 μm, combined with emitters with a peak wavelength in the short-wave infrared range between 0.7 μm and 2 μm, or long-wave IR emitters combined with emitters of non-coherent electro-magnetic radiation with a narrow spectrum between 0.3 μm and 1.5 μm, preferably in the visible range,
or broadband medium-wave IR emitters in the range from 3 μm to 1.6 μm combined with short-wave IR emitters with peak wavelengths in the range from 0.7 μm to 1.6 μm, preferably the 3D printing device comprises as emitters ceramic emitters, panel-type emitters, quartz halogen emitters, quartz tungsten emitters, heating conductors, quartz glass tubes, carbon emitters, near-infrared emitters, LED arrays with different wavelengths, gas discharge lamps, incandescent lamps, or heating wires, or/and
wherein the 3D printing device comprises an additional emitter unit, wherein the emitter unit is characterized by being an array of multiple emitters, each of which is individually controllable with regard to its temperature, or a subset of emitters being combined to a group, each group of emitters being controllable with regard to its temperature, or/and
wherein a target temperature is set at each emitter or group of emitters, with the proviso that the power (watts) of the emitter is not set as a target parameter, or/and
wherein substantially each emitter or group of emitters in the emitter unit is set to a different target temperature.

4. The 3D printing device of claim 3, wherein the emitter unit comprises a control circuit for target temperature adjustment of each emitter or/and for target temperature adjustment on the build field.

5. The 3D printing device of claim 3 wherein the emitter unit uses an algorithm to achieve a target temperature on the build field by means of target temperature setting in the emitter unit or/and wherein the target temperature setting is achieved by defining emitters as a subset of emitters combined to a group.

6. The 3D printing device of claim 3, wherein the emitter unit comprises at least one thermographic camera directed at the build field and/or at least one infrared pyrometer and/or at least one temperature sensor, preferably wherein the temperature sensor is a thermocouple or a resistance thermometer.

7. The 3D printing device of claim 6, wherein the thermographic camera is used for local measurement recordings and the infrared pyrometer is used for calibration of the absolute temperature values.

8. The 3D printing device of claim 2, comprising an emitter unit, wherein a target temperature on the build field is adjustable by a target temperature setting of each emitter in the emitter unit.

9. A high-speed sintering process or a laser sintering process or a sintering process for producing a molding by means of particle material application and selective solidification, the process comprising all further process steps and process means necessary for a 3D printing process, the process being carried out in a build area which is characterized by an X-axis and a Y-axis, forming the build field, and a Z-axis, wherein the size ratio Y>X>Z is present in the build area and/or wherein the ratio of Y:X is between 1.1 and 3.0, preferably 1.2 to 2.0.

10. The process according to claim 9, wherein the process is carried out in a build area, characterized in that the recoater extends substantially along the length Y and is moved in the X-direction, or/and
wherein the process is performed using a device, wherein the recoater, the print head and/or the sintering emitter assembly are narrow in the X-direction, preferably in total smaller than the build field in the X-direction, particularly preferably smaller than 80% of the build field in the X-direction, or/and
wherein the process is performed using a device, wherein the recoater, the print head and/or the sintering emitter assembly substantially extend over the length Y and/or are moved along the X-axis, or/and
wherein the process is performed using a device, wherein the printing modules of the print head are arranged in a comb-like manner, or/and
wherein the process is performed using a device, wherein the 3D printing device comprises a means for heat dissipation, preferably wherein one or more or all of the heat-carrying elements are coupled with a coolant, or/and
wherein the process is performed using a device, wherein the means for heat dissipation is air or a gas or a gas mixture or a cooling liquid, e.g., oil-based, water or a water-based mixture, or a system of heat pipes, or/and
wherein the process is performed using a device, comprising a sintering assembly,
wherein the sintering assembly is cooled by air or a gas or a gas mixture or/and a cooling liquid or/and by means of heat pipes, or/and
wherein the 3D printing device comprises one, two or more radiation transducers, preferably primary and/or secondary radiation transducers, or/and
wherein the 3D printing device comprises emitters of broadband electro-magnetic radiation of different wavelengths, the spectrum of which deviates from each other to a considerable extent, preferably long-wave IR emitters with a peak wavelength between 3 μm and 5.5 μm, combined with emitters with a peak wavelength in the short-wave infrared range between 0.7 μm and 2 μm, or long-wave IR emitters combined with emitters of non-coherent electro-magnetic radiation with a narrow spectrum between 0.3 μm and 1.5 μm, preferably in the visible range, or broadband medium-wave IR emitters in the range from 3 μm to 1.6 μm combined with short-wave IR emitters with peak wavelengths in the range from 0.7 μm to 1.6 μm, or/and
which uses a printing device according to any one of claims 1 to 8.

11. The 3D printing device according to claim 1, wherein the size ratio Y>X>Z is present in the build area and wherein the ratio of Y:X is between 1.2 and 2.0

12. The 3D printing device according to claim 1, wherein
the 3D printing device includes a recoater extending substantially along the length Y and moved in the X-direction; and
the recoater, a print head and/or a sintering emitter assembly are narrow in the X-direction, and smaller than 80% of the build field in the X-direction.

13. The 3D printing device according to claim 12, wherein
printing modules of a print head are arranged in a comb-like manner.

14. The 3D printing device according to claim 12, wherein:
the 3D printing device comprises a means for heat dissipation;
the means for heat dissipation is air or a gas or a gas mixture or a cooling liquid, e.g., oil-based, water or a water-based mixture, or a system of heat pipes;
the sintering assembly is cooled by air or a gas or a gas mixture or/and a cooling liquid or/and by means of heat pipes;
the sintering assembly is characterized by a closed air-cooling circuit and a liquid-based cooling circuit and wherein the air, or a gas or a gas mixture is circulated in the closed air-cooling circuit;
the liquid-based cooling circuit is arranged on a side facing away from the build field or/and is coupled with a further coolant;
the closed air-cooling circuit is at least partially guided past a radiation transducer; and
means for enlarging the surface area are arranged in the air-cooling circuit, including cooling ribs, cooling fins, cooling coils, or cooling helixes coupled to the liquid-based cooling circuit.

15. The 3D printing device according to claim 14, wherein
an IR emitter is disposed between a primary and secondary radiation transducer and the liquid-based cooling circuit, and a reflector is disposed between the IR emitter and a liquid-flow cooling member; and
a dimension of the build field in the Y-direction is 50 cm or more and the build area dimension in the Z-direction is 50 cm or less.

16. The 3D printing device according to claim 14, wherein
the liquid-based cooling circuit is cooled by means of a liquid-flow cooling member on the outside of the sintering assembly, the cooling member being a supporting lid;
cavities for the closed air-cooling circuit are located between the primary and secondary radiation transducers and between the primary radiation transducer and the supporting lid, and/or cavities are located in the side walls of the sintering assembly, all cavities communicating with each other to form a closed air-cooling circuit.

17. The 3D printing device according to claim 16, wherein
a reflector is disposed in the cavity between the primary radiation transducer and the supporting lid; and
the closed air-cooling circuit has no connection to the ambient air; and
the 3D printing device comprises a primary and a secondary radiation transducer.

18. The 3D printing device according to claim 14, wherein
the 3D printing device comprises emitters of broadband electro-magnetic radiation of different wavelengths, the spectrum of which deviates from each other to a considerable extent, including long-wave IR emitters with a peak wavelength between 3 μm and 5.5 μm, combined with emitters with a peak wavelength in the short-wave infrared range between 0.7 μm and 2 μm, or long-wave IR emitters combined with emitters of non-coherent electro-magnetic radiation with a narrow spectrum between 0.3 μm and 1.5 μm, or broadband medium-wave IR emitters in the range from 3 μm to 1.6 μm combined with short-wave IR emitters with peak wavelengths in the range from 0.7 μm to 1.6 μm.

19. The 3D printing device according to claim 14, wherein
the 3D printing device comprises as emitters ceramic emitters, panel-type emitters, quartz halogen emitters, quartz tungsten emitters, heating conductors, quartz glass tubes, carbon emitters, near-infrared emitters, LED arrays with different wavelengths, gas discharge lamps, incandescent lamps, or heating wires;
the 3D printing device comprises an additional emitter unit, wherein the emitter unit is characterized by being an array of multiple emitters, each of which is individually controllable with regard to its temperature, or a subset of emitters being combined to a group, each group of emitters being controllable with regard to its temperature, and
a target temperature is set at each emitter or group of emitters, with the proviso that the power (watts) of the emitter is not set as a target parameter, or/and wherein substantially each emitter or group of emitters in the emitter unit is set to a different target temperature.

20. The 3D printing device of claim 12, wherein the emitter unit comprises at least one thermographic camera directed at the build field and/or at least one infrared pyrometer and/or at least one temperature sensor, wherein the temperature sensor is a thermocouple or a resistance thermometer.
